(19) United States
(12) Patent Application Publication
(10) Pub. No.: US 2007/0226925 A1
(43) Pub. Date: Oct. 4, 2007

(54) SUBSTRATE TREATMENT APPARATUS AND SUBSTRATE TREATMENT METHOD

(76) Inventors: Nobuyasu Hiraoka, Kyoto (JP); Tsuyoshi Okumura, Kyoto (JP); Akiyoshi Nakano, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/694,078

(22) Filed: Mar. 30, 2007

(30) Foreign Application Priority Data
Mar. 30, 2006 (JP) 2006-095550

(51) Int. Cl. B08B 1/04

(52) U.S. Cl. 15/102; 15/77; 15/88.2

(57) ABSTRACT

A substrate treatment apparatus of the present invention includes a substrate holding mechanism for holding a substrate, a brush made of an elastically deformable material and having a cleaning surface intersecting a parallel direction along one surface of the substrate held by the substrate holding mechanism, a brush moving mechanism for moving the brush with respect to the substrate held by the substrate holding mechanism, a control unit for controlling the brush moving mechanism so that the cleaning surface is made to contact with the peripheral end face of the substrate held by the substrate holding mechanism, and a pushing pressure holding mechanism for holding the pushing pressure of the brush to the peripheral end face of the substrate in the parallel direction at a preset pushing pressure.

### BACKGROUND OF THE INVENTION

1. Field of the Invention

The present invention relates to a substrate treatment apparatus and a substrate treatment method for cleaning substrates. Substrates to be treated include semiconductor wafers, substrates for liquid crystal displays, substrates for plasma displays, substrates for FEDs (Field Emission Displays), substrates for optical discs, substrates for magnetic discs, substrates for magneto-optical discs, substrates for photomasks, etc.

2. Description of Related Art

In semiconductor device manufacturing processes, contaminants attached to the peripheral portion of a semiconductor wafer may have nonnegligible influence on the quality of the treated semiconductor wafer.

In the so-called batch treatment process, multiple semiconductor wafers are held in a vertical posture and immersed in treatment liquid. Hence, if contaminants are attached to the peripheral portion of each semiconductor wafer, the contaminants are dispersed into the treatment liquid and attached again to the device forming area on the front surface of the semiconductor wafer.

Therefore, in recent years, the need for cleaning the peripheral portions of substrates, such as semiconductor wafers, has increased.

As prior art regarding the cleaning of the peripheral portions of substrates, the configurations proposed in Document 1 (Japanese Unexamined Patent Publication No. 2003-197592), Document 2 (Japanese Unexamined Patent Publication No. 2003-151943) and Document 3 (U.S. Pat. No. 6,550,091) can be taken as examples.

Document 1 proposes a configuration in which a cylindrical brush is provided, and the outer circumferential face of the brush is made to contact with the peripheral end face of a substrate while the substrate is rotated, thereby removing contaminants attached to the peripheral end face of the substrate.

Document 2 proposes a configuration similar to the configuration proposed in Document 1, in which a cylindrical brush is pushed to the peripheral end face of a substrate, and the peripheral end face of the substrate is allowed to bite into the outer circumferential face of the brush so that contaminants attached to the peripheral end face of the substrate can be removed more satisfactorily regardless of the shape of the peripheral end face of the substrate. Furthermore, another configuration has been proposed in which a groove corresponding to the shape of the peripheral end face of the substrate is formed in the outer circumferential face of a brush and the peripheral end face of the substrate is fitted in the groove.

Document 3 proposes a configuration in which a groove into which the peripheral portion of a substrate can be fitted is formed in the outer circumferential surface of a cylindrical brush, the substrate is rotated while the peripheral portion of the substrate is fitted in this groove, and the brush is rotated around its central axis, whereby the peripheral areas (the ring-shaped areas with a predetermined width from respective peripheral edges on the front surface and the back surface of the substrate) on the front surface and the back surface and the peripheral end face of the substrate are cleaned.

However, in the configurations according to the respective proposals described above, the pushing pressure to the peripheral end face of the substrate varies depending on the position of the substrate with respect to the brush, and there is a fear of causing uneven cleaning and nonuniform cleaning width.

### SUMMARY OF THE INVENTION

An object of the present invention is to provide a substrate treatment apparatus and a substrate treatment method capable of satisfactorily cleaning the peripheral end face of a substrate, regardless of the position of the substrate with respect to a brush.

A substrate treatment apparatus according to the present invention includes a substrate holding mechanism for holding a substrate; a brush made of an elastically deformable material and having a cleaning surface intersecting a direction parallel with one surface of the substrate held by the substrate holding mechanism; a brush moving mechanism for moving the brush with respect to the substrate held by the substrate holding mechanism; a control unit for controlling the brush moving mechanism so that the cleaning surface is made to contact with the peripheral end face of the substrate held by the substrate holding mechanism; and a pushing pressure holding mechanism for holding the pushing pressure of the brush in the parallel direction to the peripheral end face of the substrate at a preset pushing pressure.

According to this configuration, the brush moving mechanism for moving the brush is controlled, and then the cleaning surface of the brush is made to contact with the peripheral end face of the substrate. At this time, the pushing pressure of the brush in the parallel direction to the peripheral end face of the substrate is held at the preset pushing pressure, regardless of the position of the substrate with respect to the brush, by virtue of the operation of the pushing pressure holding mechanism.

For example, when a configuration is used in which the substrate is rotated while the brush is in contact with the peripheral end face of a substrate, if the rotation center is deviated from the center of the substrate and the substrate is rotated eccentrically, the pushing pressure of the brush in the parallel direction to the peripheral end face of the substrate changes periodically. Hence, a portion to which the brush is pushed relatively strongly and a portion to which the brush is pushed relatively weakly are generated on the peripheral end face of the substrate. As a result, there is a fear of causing insufficient cleaning at the portion to which the brush is pushed relatively weakly.

Since the pushing pressure of the brush in the parallel direction to the peripheral end face of the substrate is held at the preset pushing pressure, even if the position of the substrate with respect to the brush is deviated from the normal position owing to the eccentric rotation of the substrate and the like, the brush is always pushed to the peripheral end face of the substrate with the preset pushing pressure. Hence, the peripheral end face of the substrate can be cleaned satisfactorily, without causing uneven cleaning.

The cleaning surface may be a conical surface having a central axis extending in a direction orthogonal to the parallel direction. In other words, the cleaning surface is formed into a conical surface having a central axis extending in a direction orthogonal to the parallel direction parallel with one surface of the substrate and being inclined at a constant angle with respect to the direction orthogonal to the parallel direction. Hence, the cleaning surface of the brush can be made contact with the peripheral area on the one surface of the substrate by pushing the cleaning surface to the peripheral end face of the substrate and elastically deforming the brush to allow the peripheral portion of the substrate to bite into the cleaning surface. As a result, the cleaning of the peripheral end face of the substrate and the peripheral area on the one surface of the substrate can be attained simultaneously.

In addition, since the inclination angle (in the range of 0 degrees or more to 90 degrees or less) of the cleaning surface with respect to a direction perpendicular to the one surface of the substrate is constant, the effective contact width (the cleaning width by the brush) between the peripheral area on the one surface of the substrate and the cleaning surface becomes the same, when the pushing pressure of the brush in the parallel direction to the peripheral end face of the substrate is the same, regardless of into which area of the cleaning surface the peripheral portion of the substrate is allowed to bite. Hence, when a partial area of the cleaning surface is worn out by the cleaning of the substrate or when contaminants are accumulated excessively in the area, the other area of the cleaning surface is used, whereby the peripheral area on the one surface and the peripheral end face of the substrate can be cleaned satisfactorily without interruption.

The cleaning surface may be a cylindrical surface having a central axis extending in a direction orthogonal to a parallel direction parallel with the one surface of the substrate. In this case, the peripheral end face of the substrate in particular can be cleaned satisfactorily.

It is preferable that a groove is formed in the cleaning surface. Since the groove is formed in the cleaning surface of the brush, contaminants relatively firmly attached to the peripheral portion of the substrate can be scraped off by the brush. The contaminants scraped off from the peripheral portion of the substrate can be removed through the groove from the space between the cleaning surface and the substrate. Hence, the substrate can be cleaned further satisfactorily.

It is preferable that the brush has a rotationally symmetrical shape and that the substrate treatment apparatus includes a brush rotation mechanism for rotating the brush around the central axis thereof. In this case, the peripheral end face of the substrate can be scrubbed by rotating the brush by the brush rotation mechanism while the cleaning surface of the brush is pushed to the peripheral end face of the substrate. Hence, the peripheral end face of the substrate can be cleaned more satisfactorily.

It is preferable that the substrate treatment apparatus includes a brush relative movement mechanism for relatively moving the substrate held by the substrate holding mechanism and the brush so that the brush is moved in a circumferential direction of the substrate. In this case, by virtue of the relative movement of the brush and the substrate, the substrate can be cleaned efficiently.

It is preferable that the substrate treatment apparatus includes a treatment liquid supply mechanism for supplying a treatment liquid to an area located more inward than the peripheral area on at least the one surface of the substrate held by the substrate holding mechanism. In this case, contaminants attached to the area located more inward than the peripheral area on the one surface of the substrate can be cleaned away by the treatment liquid. In particular, when the inward area on the one surface of the substrate is a device forming area and a treatment liquid that does not adversely affect the device forming area, for example, pure water or functional water, is used as the treatment liquid, the treatment liquid also acts as a protective liquid. Hence, the contaminants removed from the peripheral portion of the substrate by the brush can be prevented from entering the device forming area. Therefore, the device forming area can be prevented from being polluted by the contaminants.

A substrate treatment method according to the present invention includes a substrate holding step for holding a substrate by a substrate holding mechanism; a brush contact step for moving a brush made of an elastically deformable material and having a cleaning surface intersecting a parallel direction along one surface of the substrate held by the substrate holding mechanism to make the cleaning surface of the brush in contact with the peripheral end face of the substrate held by the substrate holding mechanism; and a pushing pressure holding step for holding the pushing pressure of the brush in the parallel direction to the peripheral end face of the substrate at a preset pushing pressure in the brush contact step.

In the brush contact step, the cleaning surface of the brush is made to contact with the peripheral end face of the substrate. At this time, the pushing pressure of the brush in the parallel direction to the peripheral end face of the substrate is held at the preset pushing pressure, regardless of the position of the substrate with respect to the brush. Hence, even if the position of the substrate with respect to the brush is deviated from the normal position owing to the eccentric rotation of the substrate, the brush is always pushed to the peripheral end face of the substrate with the preset pushing pressure. As a result, the peripheral end face of the substrate can be cleaned satisfactorily, without caby uneven cleaning.

The above-mentioned and other objects, features and effects of the present invention will become apparent from the following descriptions of embodiments with reference to the accompanying drawings.

### BRIEF DESCRIPTION OF THE DRAWINGS

FIG. 1 is a plan view showing the schematic configuration of a substrate treatment apparatus according to an embodiment of the present invention;

FIG. 2 is an illustrative side view showing the interior of the substrate treatment apparatus;

FIG. 3 is a sectional view showing the configuration of a brush;

FIG. 4 is a sectional view showing the configuration of a swinging arm;

FIG. 5 is a block diagram illustrating the electrical configuration of the substrate treatment apparatus;

FIG. 6 is a process chart for explaining wafer treatment in the substrate treatment apparatus;

FIG. 7 is a side view showing a state of the brush during the wafer treatment;

FIG. 8 is an illustrative side view showing the interior of a substrate treatment apparatus according to another embodiment of the present invention;

FIG. 9 is a side view showing another configuration (a configuration in which grooves are formed in the cleaning surface) of the brush; and

FIG. 10 is a side view showing a still another configuration (a configuration in which the cleaning surface is a generally cylindrical surface) of the brush.

### DETAILED DESCRIPTION OF THE PREFERRED EMBODIMENTS

Embodiments according to the present invention will be described below in detail referring to the accompanying drawings.

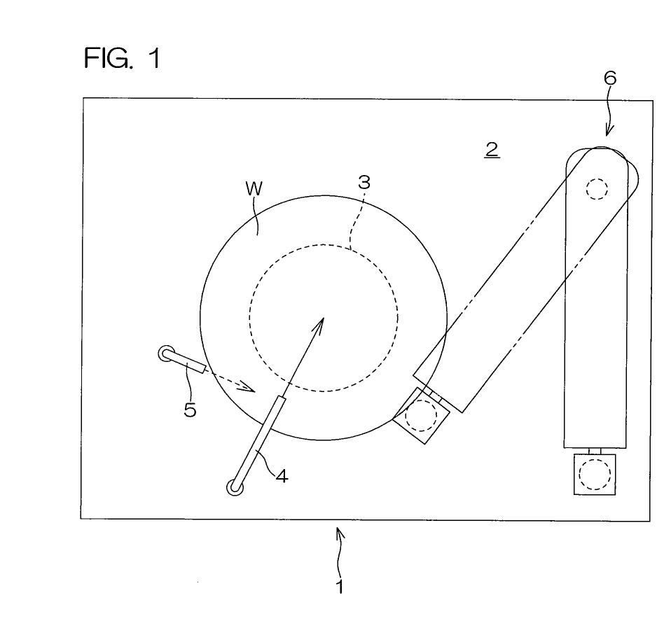

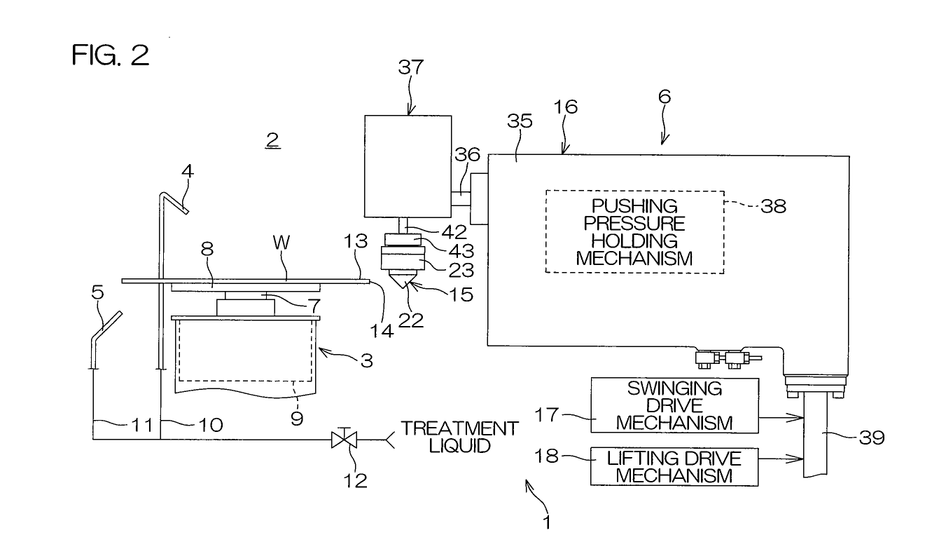

FIG. 1 is a plan view showing the schematic configuration of a substrate treatment apparatus according to an embodiment of the present invention. FIG. 2 is an illustrative side view showing the interior of the substrate treatment apparatus shown in FIG. 1.

This substrate treatment apparatus 1 is of a single wafer processing type for processing semiconductor wafers W (hereinafter referred to simply as “wafer W”) as an example of a substrate one by one. The substrate treatment apparatus 1 includes a spin chuck 3 for holding a wafer W generally horizontally and rotating it, a front surface nozzle 4 for supplying a treatment liquid to the front surface (the surface on which devices are formed) of the wafer W, a back surface nozzle 5 for supplying a treatment liquid to the back surface of the wafer W, and a brushing mechanism 6 for cleaning the peripheral portion of the wafer W, inside a treatment chamber 2 divided by a partition wall.

The spin chuck 3 is a vacuum suction chuck. The spin chuck 3 includes a spin shaft 7 extending in a generally vertical direction, a suction base 8 mounted to the upper end of the spin shaft 7 for sucking and holding the back surface (lower face) of the wafer W in a generally horizontal posture, and a spin motor 9 having a rotation shaft coaxially connected to the spin shaft 7. With this configuration, when the spin motor 9 is driven while the back surface of the wafer W is sucked and held by the suction base 8, the wafer W is rotated around the central axis of the spin shaft 7.

Treatment liquid supply pipes 10 and 11 are connected to the front surface nozzle 4 and the back surface nozzle 5, respectively. To these treatment liquid supply pipes 10 and 11, a treatment liquid is supplied from a treatment liquid supply source not shown via a treatment liquid valve 12. The front surface nozzle 4 discharges the treatment liquid supplied through the treatment liquid supply pipe 10 toward the center of the front surface of the wafer W held by the spin chuck 3. In addition, the back surface nozzle 5 discharges the treatment liquid supplied through the treatment liquid supply pipe 11 toward the area between the peripheral end edge of the back surface of the wafer W held by the spin chuck 3 and the suction base 8.

Pure water is used as the treatment liquid. Instead of pure water, it may be possible to use functional water such as carbonated water, ionized water, ozone water, regenerated water (hydrogen water) or magnetic water, as the treatment liquid. Furthermore, it is also possible to use a chemical liquid, such as ammonia water, or a mixture of ammonia water and a hydrogen peroxide solution, as the treatment liquid.

The brushing mechanism 6 includes a brush 15 for cleaning the peripheral area 13 (for example, ring-shaped areas with a width of 1 to 4 mm from the peripheral edge of the wafer W) on the front surface and the peripheral end face 14 of the wafer W, a swinging arm 16 holding this brush 15 at the tip end thereof, a swinging drive mechanism 17 for swinging the swinging arm 16 in the horizontal direction around the vertical axis set outside the rotation range of the wafer W, and a lifting drive mechanism 18 for raising and lowering the swinging arm 16.

The peripheral portion of the wafer W is a portion including the peripheral area 13 on the front surface and the peripheral end face 14 of the wafer W.

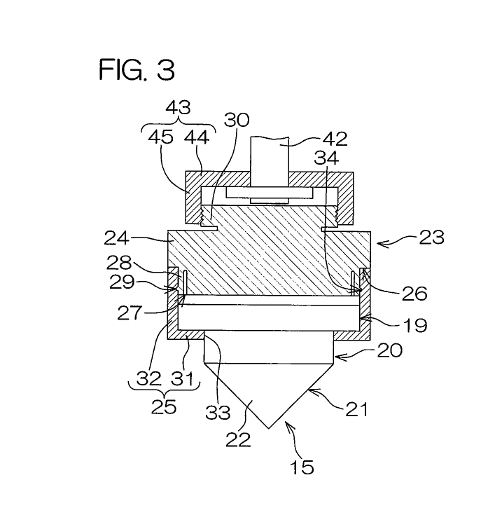

FIG. 3 is a sectional view showing the configuration of the brush 15.

The brush 15 is made of a sponge material (porous material) formed of an elastically deformable material, such as PVA (polyvinyl alcohol) and urethane. The brush 15 integrally includes a base portion 19 having a generally disc-like shape, a body portion 20 provided on one face of this base portion 19 and having a generally disc-like shape (flat cylindrical shape) the diameter of which is smaller than that of the base portion 19, and a tip end portion 21 provided at the tip end of this body portion 20 and having a generally conical shape. The base portion 19, the body portion 20 and the tip end portion 21 have the same central axis. The brush 15 has a shape being rotationally symmetrical around the central axis thereof. The upper end edge of the side surface of the tip end portion 21 is continuous with the side surface of the body portion 20. The side surface of the tip end portion 21 is a conical surface inclined at an inclination angle of 45 degrees with respect to the vertical direction (the central axis) so as to come closer to the central axis as it approaches the lower portion of itself. The side surface of the tip end portion 21 serves as a cleaning surface 22 that is pushed to the peripheral area 13 and the peripheral end face 14 of the wafer W.

The brush 15 is held by a brush holder 23. The brush holder 23 includes a resin block 24 having a generally columnar shape; and a fixing member 25 for fixing the brush 15 to this resin block 24.

A fitting groove 26 having a generally rectangular shape in section is formed around the entire circumference of the circumferential surface of one end portion of the resin block 24. In addition, on the one end portion of the resin block 24, a slit groove 27 having a generally U shape in section is formed in the circumferential direction at a position spaced away from the fitting groove 26 with a very small distance inward in the radial direction. With this configuration, the portion between the fitting groove 26 and the slit groove 27 serves as an elastic piece 28 to which the elasticity due to the flexibility of the resin is given. On the outer circumferential surface of this elastic piece 28, a plurality of hemispherical engaging protrusions 29 are formed. On the other hand, on the end surface on the other side of the resin block 24, a flat columnar screw portion 30 is formed integrally. On the circumferential surface of this screw portion 30, a screw is formed which can be screw-engaged with the screw thread formed in the holder mounting portion 43 described later.

The fixing member 25 integrally includes a disc portion 31 having a generally circular outer shape and a cylindrical portion 32 having a generally cylindrical shape and extending from the peripheral edge of this disc portion 31 to one side thereof. At the central portion of the disc portion 31, an insertion hole 33 for allowing the body portion 20 of the brush 15 to insert therethrough is formed. The inner diameter of the cylindrical portion 32 is generally equal to the outer diameter of the base portion 19 of the brush 15. In addition, the inner diameter of the cylindrical portion 32 is made slightly smaller than the outer diameter of the elastic piece 28 when no external force is applied to the elastic piece 28. Further, on the inner circumferential surface of the cylindrical portion 32, a plurality of engaging concave portions 34 that can be engaged with the respective engaging protrusions 29 are formed.

The body portion 20 of the brush 15 is inserted into the insertion hole 33 of the fixing member 25, the base portion 19 is accommodated in the cylindrical portion 32 of the fixing member 25, the cylindrical portion 32 is fitted on the fitting groove 26 of the resin block 24, and the engaging protrusions 29 are engaged with the respective engaging concave portions 34. As a result, the brush 15 is held by the brush holder 23.

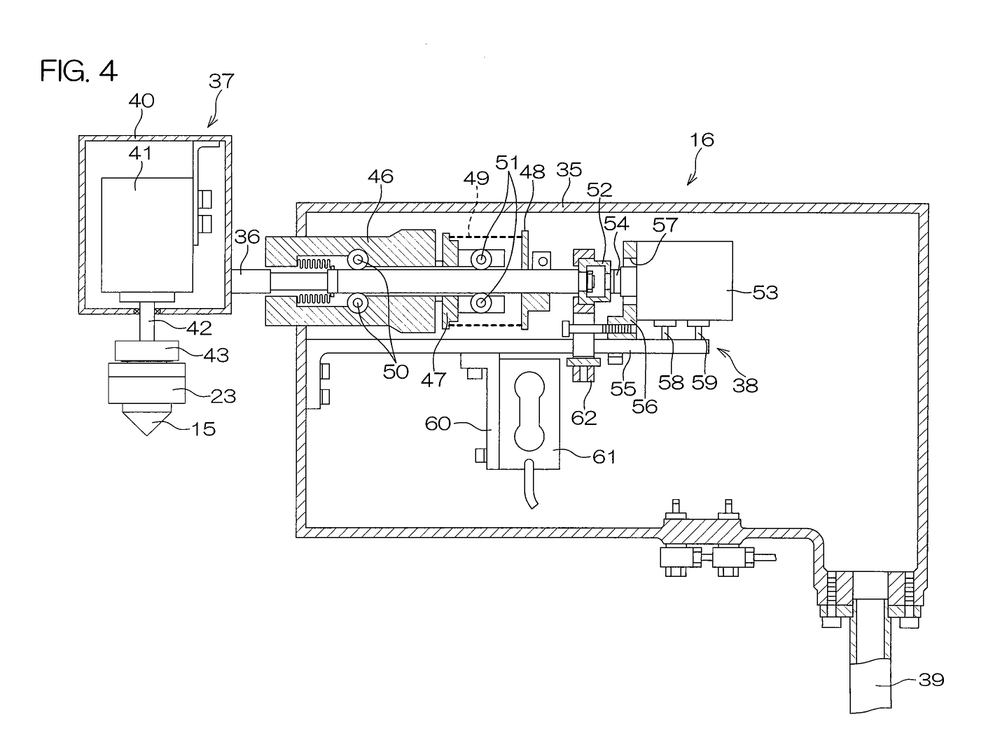

FIG. 4 is a sectional view showing the configuration of the swinging arm 16.

The swinging arm 16 includes an arm body 35 being hollow and extending in the horizontal direction; a supporting shaft 36 protruding on one side of the horizontal direction of this arm body 35; a brush rotation mechanism 37 supported at the tip end of this supporting shaft 36; and a pushing pressure holding mechanism 38 disposed inside the arm body 35 and holding the pushing pressure of the brush 15 in the horizontal direction to the peripheral end face 14 of the wafer W (the pressure applied when the brush 15 is pushed to the peripheral end face 14) at a preset pushing pressure.

To the other side of the arm body 35 in the horizontal direction (the side opposite to the side where the supporting shaft 36 protrudes), the upper end portion of an arm base shaft 39 extending in the vertical direction is connected. To this arm base shaft 39, the drive force of the swinging drive mechanism 17 (see FIG. 2) is input. The swinging arm 16 can be swung around the arm base shaft 39 by inputting the drive force of the swinging drive mechanism 17 to the arm base shaft 39 to reciprocally rotate the arm base shaft 39. Furthermore, to the arm base shaft 39, the lifting drive mechanism 18 (see FIG. 2) is connected. The swinging arm 16 can be raised and lowered together with the arm base shaft 39 by raising and lowering the arm base shaft 39 by the lifting drive mechanism 18.

The brush rotation mechanism 37 includes a casing 40 and a brush motor 41 provided inside this casing 40. An output shaft 42 of the brush motor 41 penetrates the lower surface of the casing 40 and extends downward in the vertical direction.

A holder mounting portion 43 is provided at the lower end portion of the output shaft 42. This holder mounting portion 43 integrally includes a disc-like upper surface portion 44 through which the output shaft 42 is inserted and which is fixed to the output shaft 42, and a cylindrical side surface portion 45 extending downward from the peripheral edge of this upper surface portion 44, as shown in FIG. 3. The inner circumferential surface of the side surface portion 45 is provided with a screw thread that can be screw-engaged with the screw thread formed on the screw portion 30 of the brush holder 23. With this configuration, the brush holder 23 can be screwed into the holder mounting portion 43.

The brush 15 is held by the brush holder 23, and the brush holder 23 is screwed into the holder mounting portion 43. When the brush motor 41 is driven in this state, the brush 15 is rotated around the central axis thereof extending along the output shaft 42.

Furthermore, as shown in FIG. 4, a first guide roller supporting member 46, a second guide roller supporting member 47 and a spring hooking member 48 are fitted around the supporting shaft 36.

The first guide roller supporting member 46 is provided so as to penetrate the wall on the side where the supporting shaft 36 of the arm body 35 protrudes and is fitted around the supporting shaft 36 with a very small clearance from the circumferential surface of the supporting shaft 36 in a noncontact state.

The second guide roller supporting member 47 is provided inside the arm body 35 and fixed to the first guide roller supporting member 46. Furthermore, the second guide roller supporting member 47 is fitted around the supporting shaft 36 with a very small clearance from the circumferential surface of the supporting shaft 36 in a noncontact state.

The spring hooking member 48 is provided inside the arm body 35 and on the side opposite to the first guide roller supporting member 46 with respect to the second guide roller supporting member 47. The spring hooking member 48 is fixed to the supporting shaft 36. One end of a coil spring 49 is hooked to the spring hooking member 48. The coil spring 49 is interposed between the spring hooking member 48 and the second guide roller supporting member 47, and the other end of the coil spring 49 is hooked to the second guide roller supporting member 47.

In addition, the first guide roller supporting member 46 supports a pair of guide rollers 50. The second guide roller supporting member 47 supports a pair of guide rollers 51. The guide rollers 50 and 51 are provided so that they are rotatable around shafts extending in a direction orthogonal to the supporting shaft 36 and their circumferential surfaces make contact with the circumferential surface of the supporting shaft 36. Therefore, the horizontal movement of the supporting shaft 36 can be guided by the guide rollers 50 and 51, and the resistance at the time of the horizontal movement can be reduced.

On the other hand, at the end portion of the supporting shaft 36 on the opposite side of the side where the casing 40 is provided, a contact member 52 is mounted.

The pushing pressure holding mechanism 38 includes an air cylinder 53 provided on the side of the contact member 52. This air cylinder 53 is provided so that a rod 54 thereof is advanced to and retreated from the contact member 52 in the axial center direction of the supporting shaft 36. More specifically, a supporting plate 55 having a generally L shape in side view extends in the horizontal direction from the inner surface of the side wall of the arm body 35 through which the first guide roller supporting member 46 passes is inserted. On this supporting plate 55, a cylinder mounting plate 56 extending to a position opposed to the contact member 52 on the opposite side of the supporting shaft 36 is supported. The air cylinder 53 is mounted on the surface of the cylinder mounting plate 56 on the opposite side of the contact member 52, and the rod 54 thereof is inserted through a rod insertion hole 57 formed in the cylinder mounting plate 56. The tip end of the rod 54 is in contact with the contact member 52.

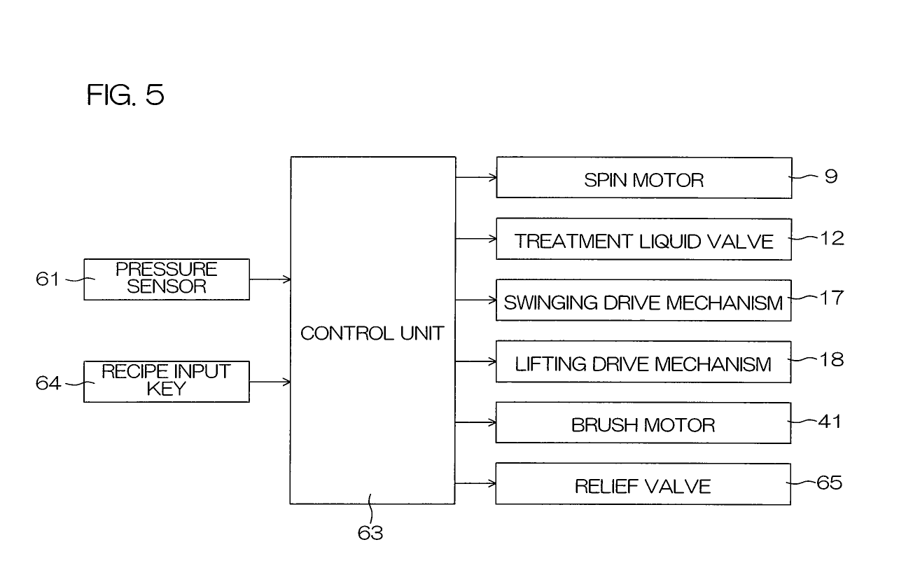

The interior of the air cylinder 53 is divided into two spaces in the advance/retreat direction (vertical direction) of the rod 54 by a piston (not shown) fixed to the base end of the rod 54. To the space on the side of the rod 54 with respect to the piston, a first air supply pipe 58 includes a continuous flow valve (not shown) disposed in the inside thereof is connected. On the other hand, to the space on the opposite side of the rod 54 with respect to the piston, a second air supply pipe 59 includes a relief valve 65 (see FIG. 5) disposed in the inside thereof is connected, and the relief valve 65 is capable of changing the setting of the relief pressure thereof. When the relief pressure of the relief valve 65 is raised, the pressure of the air supplied from the second air supply pipe 59 to the air cylinder 53 rises, and the rod 54 advances from the air cylinder 53. On the other hand, when the relief pressure of the relief valve 65 is lowered, the pressure of the air supplied from the second air supply pipe 59 to the air cylinder 53 lowers, and the rod 54 retreats in the air cylinder 53 by virtue of the pressure of the air supplied from the first air supply pipe 58 to the air cylinder 53 and the urging force of the coil spring 49.

Furthermore, on the supporting plate 55, a sensor mounting plate 60 extending to the opposite side of the cylinder mounting plate 56 is supported. On this sensor mounting plate 60, a strain gauge type pressure sensor 61 is mounted.

On the other hand, a pushing pressure detection arm 62 is fixed to the contact member 52. This pushing pressure detection arm 62 extends from the contact member 52 to a position opposed to the pressure sensor 61 on the opposite side of the sensor mounting plate 60. In a state in which the brush 15 is not in contact with the wafer W, the pushing pressure detection arm 62 makes contact with the pressure sensor 61 with the pushing pressure of the air cylinder 53 to the supporting shaft 36 in the horizontal direction (corresponding to the pushing pressure of the brush 15 to the peripheral end face 14 of the wafer W in the horizontal direction). With this configuration, the pressure sensor 61 can detect the pushing pressure of the air cylinder 53 to the supporting shaft 36 in the horizontal direction.

FIG. 5 is a block diagram illustrating the electrical configuration of the substrate treatment apparatus 1.

The substrate treatment apparatus 1 includes a control unit 63 including a microcomputer. To this control unit 63, the detection signal of the pressure sensor 61 is input. In addition, to the control unit 63, a recipe input key 64 for allowing the user to input a treatment recipe (various conditions for treating the wafer W) is connected. Furthermore, to the control unit 63, the spin motor 9, the treatment liquid valve 12, the swinging drive mechanism 17, the lifting drive mechanism 18, the brush motor 41, the relief valve 65, etc., are connected as objects to be controlled.

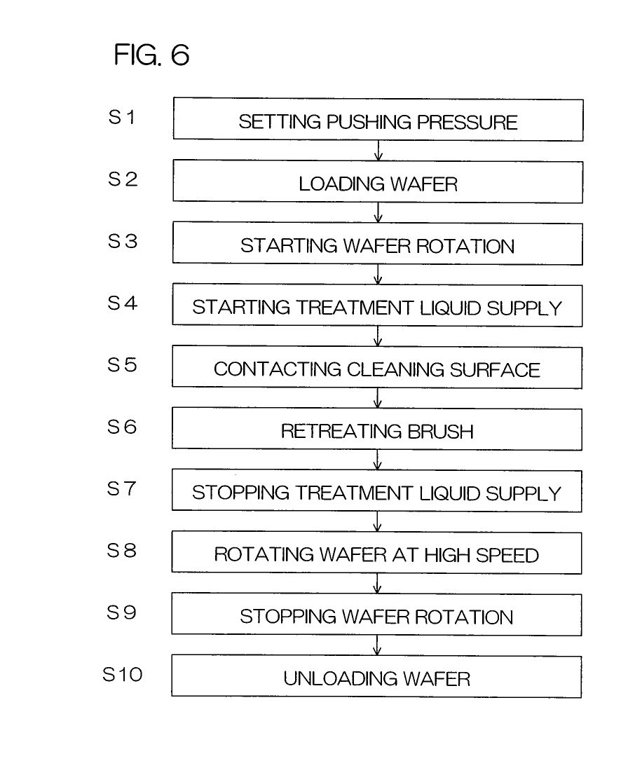

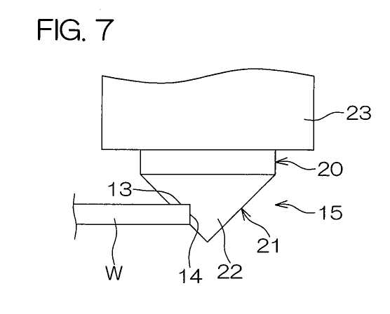

FIG. 6 is a process chart for explaining the treatment of the wafer W in the substrate treatment apparatus 1. FIG. 7 is side view showing the state of the brush 15 during the treatment of the wafer W.

Before the wafer W is treated, the recipe input key 64 is operated by the user, and the pushing pressure of the brush 15 in the horizontal direction to the peripheral area 14 of the wafer W is input. According to the input from the recipe input key 64, the relief pressure of the relief valve 65 is set by the control unit 63. More specifically, when the brush 15 is not in contact with the wafer W, the pushing pressure detection arm 62 is in contact with the pressure sensor 61. Hence, the pressure sensor 61 can detect the pushing pressure of the supporting shaft 36 by the air cylinder 53. The control unit 63 changes the relief pressure of the relief valve 65, compares the pushing pressure detected by the pressure sensor 61 with the pushing pressure input from the recipe input key 64. When the two pressures become equal, the relief pressure at this time is set as the relief pressure for the treatment of the wafer W (step S1: setting pushing pressure).

The wafer W loaded into the treatment chamber 2 is held by the spin chuck 3 (step S2). Then, the spin motor 9 is controlled by the control unit 63, and the rotation of the wafer W by the spin chuck 3 is started (step S3). The wafer W is rotated at a rotation speed of 100 rpm, for example. Next, the treatment liquid valve 12 is opened by the control unit 63, and the supply of the treatment liquid from the front surface nozzle 4 and the back surface nozzle 5 to the front surface and the back surface of the wafer W, respectively, is started (step S4).

In addition, the brush motor 41 is controlled by the control unit 63, and the brush 15 is rotated in the same rotation direction as that of the wafer W at a rotation speed of 100 to 200 rpm, for example. Then, the swinging drive mechanism 17 and the lifting drive mechanism 18 are controlled by the control unit 63, and the cleaning surface 22 of the brush 15 is made to contact the peripheral end face 14 of the wafer W (step S5) and the cleaning surface 22 is made to contact with the peripheral area 13 on the front surface and the peripheral end face 14 of the wafer W. More specifically, first, the lifting drive mechanism 18 is controlled, the brush 15 is moved to a predetermined height position, and the cleaning surface 22 of the brush 15 is opposed to the peripheral end face 14 of the wafer W. Next, the swinging drive mechanism 17 is controlled, the swinging arm 16 is swung, and the brush 15 is moved horizontally. By virtue of this horizontal movement, the peripheral portion of the wafer W bites into the cleaning surface 22 of the brush 15, and the cleaning surface 22 of the brush 15 is made to contact the peripheral area 13 on the front surface and the peripheral end face 14 of the wafer W as shown in FIG. 7.

At this time, by virtue of the operation of the pushing pressure holding mechanism 38, the brush 15 is pushed to the peripheral end face 14 of the wafer W with the constant horizontal pushing pressure set by the recipe input key 64. For example, in the case that the center of the wafer W is deviated from the rotation center of the spin chuck 3 (the central axis passing through the spin shaft 7) and that the wafer W is rotated eccentrically, when the center of the wafer W is located relatively close to the brush 15, the force of the wafer W exerted to push back the brush 15 becomes relatively large. On the other hand, when the center of the wafer W is located relatively far from the brush 15, the force of the wafer W exerted to push back the brush 15 becomes relatively small. When the force of the wafer W exerted to push back the brush 15 becomes larger, the pressure in the space on the opposite side of the rod 54 with respect to the piston inside the air cylinder 53 rises, and the pressure inside the second air supply pipe 59 rises accordingly. When the pressure inside the second air supply pipe 59 becomes equal to or higher than the relief pressure of the relief valve 65, the air inside the second air supply pipe 59 is released, and the pressure inside the second air supply pipe 59 is held at the relief pressure. Hence, while the cleaning surface 22 of the brush 15 is in contact with the peripheral area 13 on the front surface and the peripheral end face 14 of the wafer W, the pushing pressure of the brush 15 to the peripheral end face 14 of the wafer W in the horizontal direction is held at the preset pushing pressure.

Furthermore, while the peripheral area 13 on the front surface and the peripheral end face 14 of the wafer W is cleaned, contaminants attached to the central area (device forming area) located more inward than the peripheral area 13 on the front surface of the wafer W can be cleaned away by the treatment liquid supplied to the front surface of the wafer W. Further, pure water serving as the treatment liquid also serves as a protective liquid for preventing the contaminants removed from the peripheral area 13 and the peripheral end face 14 by the brush 15 from entering the central area (device forming area) on the front surface of the wafer W. When the treatment liquid is used as a protective liquid, it is preferable to select a treatment liquid that does not adversely affect the device forming area on the front surface of the wafer W, for example, carbonated water, ionized water, regenerated water (hydrogen water), or functional water such as magnetic water, in addition to pure water.

When a predetermined time has passed after the cleaning surface 22 of the brush 15 is pushed to the peripheral portion of the wafer W, the swinging drive mechanism 17 and the lifting drive mechanism 18 are controlled by the control unit 63, and the brush 15 is retreated to its home position at which the brush 15 is located before the start of the treatment (step S6). In addition, while the brush 15 is returned to its home position, the brush motor 41 is stopped, and the rotation of the brush 15 is stopped. Furthermore, the treatment liquid valve 12 is closed by the control unit 63, and the supply of the treatment liquid from the front surface nozzle 4 and the back surface nozzle 5 is stopped (step S7).

Then, the spin motor 9 is controlled by the control unit 63, and the wafer W is rotated at a high speed (for example, 3000 rpm) (step S8). Hence, the treatment liquid attached to the wafer W is spun off, and the wafer W can be dried.

After the high-speed rotation of the wafer W is continued for a predetermined time, the spin motor 9 is stopped, and the rotation of the wafer W by the spin chuck 3 is stopped (step S9). Then, after the wafer W becomes stationary, the wafer W having been treated is unloaded from the treatment chamber 2 (step S10).

As described above, the cleaning surface 22 of the brush 15 is made to contact the peripheral end face 14 of the wafer W, and at this time, by virtue of the operation of the pushing pressure holding mechanism 38, the horizontal pushing pressure of the brush 15 to the peripheral end face 14 of the wafer W is held at the preset pushing pressure, regardless of the position of the wafer W with respect to the brush 15. Hence, even if the wafer W is held by the spin chuck 3 in a state in which the center of the wafer W is deviated from the rotation center of the spin chuck 3 and the wafer W is rotated eccentrically, the brush 15 is always pushed to the peripheral end face 14 of the wafer W with the preset horizontal pushing pressure. Therefore, the peripheral end face of the wafer W can be cleaned 1 satisfactorily without causing uneven cleaning.

In addition, the cleaning surface 22 is a conical surface inclined so as to come closer to the central axis as it approaches the lower portion of itself. Hence, the cleaning surface 22 of the brush 15 can be made contact with the peripheral area 13 on the front surface of the wafer W by pushing the cleaning surface 22 to the peripheral end face 14 of the wafer W and elastically deforming the brush 15 to allow the peripheral portion of the wafer W to bite into the cleaning surface 22. As a result, the cleaning of the peripheral end face 14 of the wafer W and the cleaning of the peripheral area 13 on the front surface of the wafer W can be attained simultaneously.

Furthermore, since the inclination angle of the cleaning surface 22 with respect to the central axis thereof is constant at 45 degrees, the effective contact width (cleaning width) between the peripheral area 13 on the front surface of the wafer W and the cleaning surface 22 is the same, provided that the pushing pressure of the brush 15 to the peripheral end face 14 of the wafer W in the parallel direction is the same, whichever area of the cleaning surface 22 the peripheral portion of the wafer W is allowed to bite. Hence, when a partial area of the cleaning surface 22 is worn out by the cleaning of the wafer W or when contaminants are accumulated excessively in a partial area of the cleaning surface 22 to the extent that the cleaning of the wafer W is hindered, other areas of the cleaning surface 22 is used, whereby the peripheral area 13 on the front surface and the peripheral end face 14 of the wafer W can be cleaned satisfactorily without interruption.

In addition, while the cleaning surface 22 of the brush 15 is pushed to the peripheral portion of the wafer W, the wafer W is rotated by the spin chuck 3, and the brush 15 and the peripheral portion of the wafer W are moved relatively, whereby the peripheral portion of the wafer W can be cleaned efficiently.

Furthermore, while the cleaning surface 22 of the brush 15 is pushed to the wafer W, the brush 15 is rotated in the same direction as that of the wafer W. Hence, the peripheral portion of the wafer W can be scrubbed, and the peripheral portion of the wafer W can be cleaned further satisfactorily. The rotation direction of the brush 15 may be opposite to the rotation direction of the wafer W. However, when the rotation direction is the same as that of the wafer W, the wafer W and the brush 15 can be rubbed with each other. As a result, cleaning with higher quality can be attained.

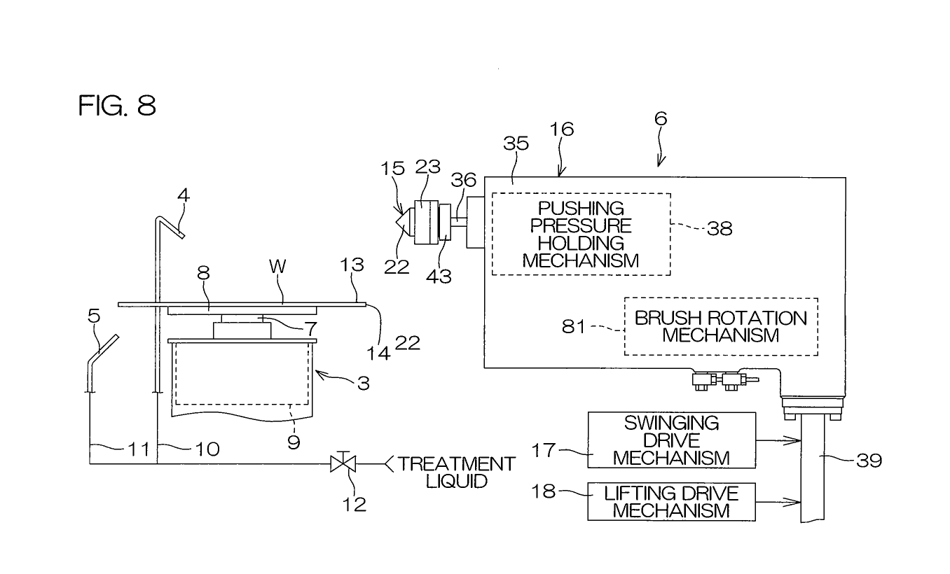

FIG. 8 is an illustrative side view showing the interior of a substrate treatment apparatus according to another embodiment of the present invention. In FIG. 8, components corresponding to the components shown in FIG. 2 are designated by the same reference numerals as those of the components shown in FIG. 2. Furthermore, detailed descriptions of the components designated by the same reference numerals are omitted below.

In the configuration described above, the brush rotation mechanism 37 is supported at the tip end portion of the supporting shaft 36, and the holder mounting portion 43 capable of being screw-engaged with the brush holder 23 is fixed to the lower end portion of the output shaft 42 of the brush motor 41 provided in the brush rotation mechanism 37. In the configuration shown in FIG. 8, the supporting shaft 36 is rotatably supported by the arm body 35, and the holder mounting portion 43 capable of being screw-engaged with the brush holder 23 is mounted on the tip end portion of the supporting shaft 36 protruding from the arm body 35. Hence, in the configuration shown in FIG. 8, the central axis of the brush 15 extends in the horizontal direction while the brush 15 is mounted on the holder mounting portion 43 via the brush holder 23. The cleaning surface 22 is a conical surface inclined at an inclination angle of 45 degrees with respect to the horizontal direction (the central axis) so as to come closer to the central axis as it approaches the tip end portion of itself.

In addition, a brush rotation mechanism 81 is provided inside the arm body 35 for rotating the supporting shaft 36 together with the first guide roller supporting member 46, the second guide roller supporting member 47 and the spring hooking member 48 (see FIG. 4), thereby rotating the brush 15 around the central axis thereof. Although the brush rotation mechanism 81 is not described herein in detail, for example, the first guide roller supporting member 46 is rotatably held by bearings, a pulley is fitted on the first guide roller supporting member 46 so as not to rotate relatively to each other, and the drive force of a motor is input to this pulley. With this configuration, the supporting shaft 36 can be rotated together with the first guide roller supporting member 46, the second guide roller supporting member 47 and the spring hooking member 48.

When the wafer W is treated, the cleaning surface 22 of the brush 15 is pushed to the peripheral area 13 on the front surface and the peripheral end face 14 of the wafer W. At this time, by virtue of the operation of the pushing pressure holding mechanism 38, the horizontal pushing pressure of the brush 15 to the peripheral end face 14 of the wafer W is held at the constant pushing pressure set by the recipe input key 64 (see FIG. 5).

With this configuration, it is also possible to attain effects similar to those of the configuration shown in FIG. 2.

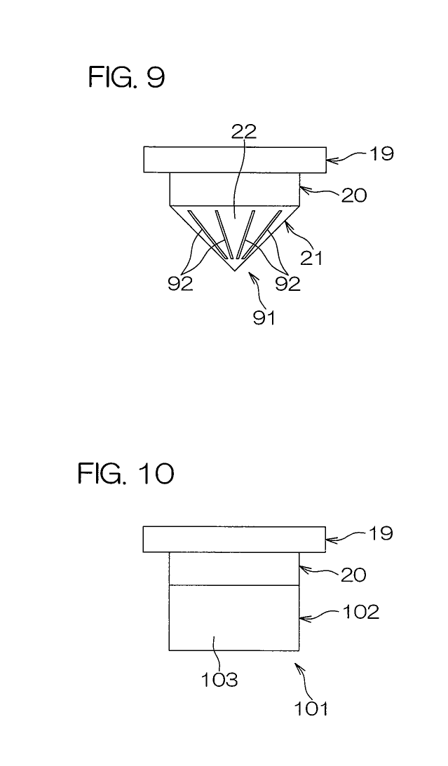

FIG. 9 is a side view showing another configuration of the brush. In FIG. 9, components corresponding to the components shown in FIG. 3 are designated by the same reference numerals as those of the components shown in FIG. 3. Furthermore, detailed descriptions of the components designated by the same reference numerals are omitted below.

A plurality of grooves 92 are formed in the cleaning surface 22 of a brush 91 shown in FIG. 9. The grooves 92 extend linearly along the generating lines of the cleaning surface 22 formed as a cone surface.

Since the grooves 92 are formed in the cleaning surface 22 of the brush 91 as described above, contaminants relatively firmly attached to the peripheral area 13 on the front surface and the peripheral end face 14 of the wafer W can be scraped off by the brush 91. Furthermore, the contaminants scraped off from the wafer W by the brush 91 can be removed through the grooves from the space between the cleaning surface 22 and the wafer W. Hence, the wafer W can be cleaned further satisfactorily by the brush 91 shown in FIG. 9.

The grooves 92 are not limited to have the linear shape formed along the generating lines of the cleaning surface 22. The grooves 92 may have a ring shape formed along the circumference of the cleaning surface 22. In addition, only one groove 92 may be formed. When only one groove 92 is formed, the groove 92 may be formed in a spiral shape.

Although some embodiments according to the present invention have been described above, the present invention can also be implemented in other embodiments. For example, although the cleaning surface 22 has an inclination angle of 45 degrees with respect to the central axis, the inclination angle of the cleaning surface 22 with respect to the central axis may be set in the range of 5 to 85 degrees. It is preferable that the inclination angle of the cleaning surface 22 with respect to the central axis is set in the range of 30 to 60 degrees in order to prevent the wafer W from being deformed by the pushing pressure of the brush while the cleaning width in the peripheral area 13 on the front surface of the wafer W is obtained securely.

In addition, instead of the brush 15 and the brush 91, the cleaning surface 22 of which is a conical surface, a brush 101 shown in FIG. 10 may also be employed. In other words, it may be possible to use the brush 101 configured such that a generally cylindrical tip end portion 102 is provided on the tip end side of the body portion 20 and the side surface of the tip end portion 102 serves as a cleaning surface 103 (cylindrical surface).

In FIG. 10, components corresponding to the components shown in FIG. 3 are designated by the same reference numerals as those of the components shown in FIG. 3. Furthermore, detailed descriptions of the components designated by the same reference numerals are omitted.

Furthermore, although the brush 15 is rotated while the brush 15 is in contact with the wafer W in the embodiments described above, the brush 15 may not be rotated but be made stationary.

Moreover, when a rectangular substrate is treated, it may be possible to employ a configuration in which the substrate is kept stationary and the brush is moved along the peripheral portion of the substrate. It may also be possible to relatively move the brush along the peripheral portion of the substrate while both the substrate and the brush are moved, as a matter of course.

Moreover, it may also be possible that at least one of a front surface cleaning brush for cleaning the central area on the front surface (upper surface) of the wafer W held by the spin chuck 3, an ultrasonic cleaning nozzle for supplying a treatment liquid to which an ultrasonic wave is added to the wafer W and a two-fluid nozzle for supplying liquid droplets generated by mixing a gas and a liquid to the wafer W is provided additionally.

Furthermore, in the embodiments described above, an apparatus for cleaning the peripheral portion of the wafer W by a treatment liquid, such as pure water, functional water or medical solution, is taken as an example. However, the substrate treatment apparatus may be an apparatus for etching the thin film of the peripheral portion of the wafer W. In this case, an etching solution including at least one of hydrofluoric acid, nitric acid, phosphoric acid, hydrochloric acid, oxalic acid and citric acid may also be used as the treatment liquid. Alternatively, the substrate treatment apparatus may be an apparatus for removing reaction products, such as a polymer, from the peripheral portion of the wafer W. In this case, a polymer removal liquid, such as an organic amine removal liquid or an ammonium fluoride removal liquid, may also be used as the treatment liquid. Furthermore, the substrate treatment apparatus may also be an apparatus for removing a resist from the peripheral portion of the wafer W. In this case, a resist removal liquid including an sulfuric acid/hydrogen peroxide water mixture (SPM) or sulfuric acid ozone may also be used as the treatment liquid.

Furthermore, these embodiments are only specific examples for clarifying the technical concepts of the present invention, and the present invention should therefore not be construed as being limited to only these specific examples. The spirit and scope of the present invention is limited only by the appended claims.

This application corresponds to Japanese Patent Application No. 2006-95550 filed with the Japan Patent Office on Mar. 30, 2006. Disclosure of the application shall be incorporated herein by reference.

What is claimed is:

1. A substrate treatment apparatus comprising:
a substrate holding mechanism for holding a substrate,
a brush made of an elastically deformable material and having a cleaning surface intersecting a parallel direction along one surface of the substrate held by the substrate holding mechanism;
a brush moving mechanism for moving the brush with respect to the substrate held by the substrate holding mechanism;
a control unit for controlling the brush moving mechanism so that the cleaning surface is made to contact with a peripheral end face of the substrate held by the substrate holding mechanism; and
a pushing pressure holding mechanism for holding a pushing pressure of the brush in the parallel direction to the peripheral end face of the substrate at a preset pushing pressure.

2. A substrate treatment apparatus according to claim 1, wherein
the cleaning surface is a conical surface having a central axis extending in a direction orthogonal to the parallel direction.

3. A substrate treatment apparatus according to claim 1, wherein
the cleaning surface is a cylindrical surface having a central axis extending in a direction orthogonal to the parallel direction.

4. A substrate treatment apparatus according to claim 1, wherein
a groove is formed in the cleaning surface.

5. A substrate treatment apparatus according to claim 1, wherein
the brush has a rotationally symmetrical shape, and
the substrate treatment apparatus comprises a brush rotation mechanism for rotating the brush around a central axis thereof.

6. A substrate treatment apparatus according to claim 1, comprising:
a brush relative movement mechanism for relatively moving the substrate held by the substrate holding mechanism and the brush so that the brush is moved in a circumferential direction of the substrate.

7. A substrate treatment apparatus according to claim 1, comprising:
a treatment liquid supply mechanism for supplying a treatment liquid to an area located more inward than a peripheral area on at least the one surface of the substrate held by the substrate holding mechanism.

8. A substrate treatment method comprising:
a substrate holding step for holding a substrate by a substrate holding mechanism;
a brush contact step for moving a brush made of an elastically deformable material and having a cleaning surface intersecting a parallel direction along one surface of the substrate held by the substrate holding mechanism to make the cleaning surface of the brush in contact with a peripheral end face of the substrate held by the substrate holding mechanism; and
a pushing pressure holding step for holding a pushing pressure of the brush in the parallel direction to the peripheral end face of the substrate at a preset pushing pressure in the brush contact step.
